(19) United States
(12) Patent Application Publication
(10) Pub. No.: US 2005/0188733 A1
(43) Pub. Date: Sep. 1, 2005

(54) Coin lock box

(76) Inventor: Gerald Blankenau, Omaha, NE (US)

Correspondence Address: Law Offices of Adam H. Jacobs;Adam H. Jacobs, Suite 726, 1904 Farnam Street, Omaha, NE, 68102, US

(21) Appl. No.: 11/065,382

(22) Filed: Feb. 24, 2005

Related U.S. Application Data
(60) Provisional application No. 60/548,522, filed on Feb. 27, 2004.

(51) Int. Cl. E05B 13/02

(52) U.S. Cl. 70/423

(57) ABSTRACT

The present invention provides a coin lock box including a coin lock box mounting section including a coin lock box retention structure, a coin slot formed in the coin lock box mounting section and a key mounted thereon and a coin lock box including an outer circumferential wall structure, a top wall, a base wall, a coin slot formed the top wall or the outer circumferential wall structure and a coin lock box access mechanism which restricts access to the coin lock box. The coin lock box access mechanism further includes a lock box access plate with an access plate coin slot, the lock box access plate movably mounted between an aligned position and an offset position. Finally, a lock device is operatively connected to the lock box access plate such that engagement with the key moves the lock box access plate between the aligned and offset positions.

### CROSS-REFERENCE TO RELATED PROVISIONAL PATENT

This application claims priority based on a provisional patent, specifically on the Provisional Patent Application Ser. No. 60/548,522 filed Feb. 27, 2004.

### BACKGROUND OF THE INVENTION

1. Technical Field

The present invention is directed to coin lock boxes and, more particularly, to an improved coin lock box which includes a top plate having a key slot through which a immovably mounted key extends downwards, the top plate also including a coin pass-through opening, a coin lock box mounting structure mounted on the underside of the top plate and including mounting pin-receiving openings in the sides thereof, and a generally cylindrical coin lock box having a side wall, base wall, and top wall, the top wall including a rotatably mounted lock mechanism connected to a rotating plate mounted underneath the top wall of the lock box such that engagement by the key and rotation of the lock box opens the top or side opening in the top or side wall of the lock box and further causes the mounting pins mounted on the side wall of the coin lock box to engage the mounting pin-receiving openings of the coin lock box mounting structure to releasably secure the coin lock box underneath the top plate.

2. Description of the Prior Art

The newspaper industry uses many different types of newspaper vending machines for distribution of newspapers. These include honor boxes, standard vending machines having a door which is opened to access the newspapers once coins are placed within the machine and single vend newspaper machines. Generally speaking, however, each of these devices have one thing in common and that is that the coin box into which coins are deposited is accessible by the newspaper route delivery driver for removal of the coins in the locked box. The advantage to this situation is that the delivery driver may easily remove the accumulated monies from the coin box and take them back to the newspaper distribution center, therefore eliminating the need for a separate money collection person. The disadvantage, however, is that a dishonest delivery route driver may steal the accumulated monies or report a smaller amount of collected money, thus depriving the newspaper company of its rightfully received income. To a great extent, newspaper companies account and allow for some degree of theft by their delivery drivers and think of it as merely the cost of doing business. However, it would be much preferable to eliminated this theft, and therefore there is a substantial need for an easy-to-use coin lock box mechanism which can be fitted into the various types of newspaper vending machines and which may be quickly and easily removed and replaced by the delivery driver while preventing access to the coins deposited therein.

Therefore, an object of the present invention is to provide an improved coin lock box.

Another object of the present invention is to provide an improved coin lock box in which the access key is retained within the coin lock box support and is not carried by the coin removal attendant, thus preventing loss and/or theft of the key which permits access to the interior of the coin lock box mechanism.

Another object of the present invention is to provide an improved coin lock box which may be quickly and easily removed and replaced within a vending machine to enhance the efficiency of use of the present invention.

Another object of the present invention is to provide an improved coin lock box which includes a coin lock box mounting structure having a stationary key mounted therein and a portable coin lock box which may be inserted into the coin lock box mounting structure so that the key engages a locking mechanism within the coin lock box to permit coins to fall within the coin lock box and be retained therein.

Another object of the present invention is to provide an improved coin lock box in which the coin slot is positioned on the top and/or side of the coin lock box to permit the unit to be used with a variety of vending devices.

Finally, an object of the present invention is to provide an improved coin lock box which is relatively simple and durable in construction and is safe, secure, and efficient in use.

### SUMMARY OF THE INVENTION

A coin lock box includes a coin lock box mounting section including a coin lock box retention structure, a coin slot formed in the coin lock box mounting section operative to permit objects to objects to enter and exit the coin lock box mounting section and a key mounted thereon and a coin lock box including an outer circumferential wall structure, a top wall mounted on the outer circumferential wall structure, a base wall mounted on the outer circumferential wall structure, a coin slot formed in one of the top wall and the outer circumferential wall structure and a coin lock box access mechanism operative to alternatively permit and restrict access to the interior of the coin lock box. The coin lock box access mechanism further includes a lock box access plate movably mounted within the coin lock box and an access plate coin slot formed in and extending through the lock box access plate, the lock box access plate movable between an aligned position where the access plate coin slot is generally aligned with the coin slot of the coin lock box thereby allowing objects to enter and exit the coin lock box and an offset position where the access plate coin slot is generally offset from the coin slot of the coin lock box thereby restricting objects from entering and exiting the coin lock box. A lock device is mounted on the coin lock box, the lock means operatively connected to the lock box access plate of the coin lock box access mechanism such that operation of the lock device moves the lock box access plate between the aligned position and the offset position. Finally, the key engages and operates the lock device upon the coin lock box being inserted and secured within the coin lock box mounting section to move the lock box access plate from the offset position to the aligned position.

As thus described, the coin lock box of the present invention provides numerous advantages over those coin reception devices found in the prior art. For example, because the key used in connection with the locking box of the present invention is kept within the vending machine at all times, it is virtually impossible for the collector of the coins to be unable to remove the coins due to loss or theft of the key. Furthermore, this feature also makes it far more unlikely that an unscrupulous individual would be able to copy the key to allow access to the contents of the coin lock box as the key is inaccessible for such a purpose. Also, because the coin lock box is quickly and easily removable from the vending machine in which it is mounted, removal and replacement of the coin lock box from the vending machine is made far more efficient than the level of efficiency permitted by those devices found in the prior art. Finally, because the positioning of the coin opening in the lock box and lock box support may be modified or changed while retaining the functionality of the coin lock box device of the present invention, the present invention may be used with a great variety of vending machines currently being produced, thus permitting retrofit installation of the improved coin lock box of the present invention. The present invention thus provides numerous advantages over those devices found in the prior art.

### BRIEF DESCRIPTION OF THE DRAWINGS

FIG. 1 is a perspective view of the coin lock box of the present invention showing a coin being inserted therein;

FIG. 2 is a perspective view of the present invention showing the coin lock box and the coin lock box mounting section of the present invention;

FIG. 3 is a detailed perspective view of the coin lock box mounting structure of the present invention showing the preferred generally rectangular shape of the mounting structure;

FIG. 4 is an exploded detailed perspective view of the coin lock box section of the present invention;

FIG. 5 is a detailed side elevational view of the present invention showing the coin lock box being inserted into the coin lock box mounting structure;

FIG. 6 is a detailed side elevational view of the present invention showing the coin lock box inserted into and mounted within the coin lock box mounting structure;

FIG. 7 is a perspective view of an alternative embodiment of the coin lock box of the present invention;

FIG. 8 is a detailed perspective view of the alternative embodiment of the coin lock box showing the modified elements thereof;

FIG. 9 is an exploded detailed perspective view of the alternative embodiment of the coin lock box of the present invention; and

FIG. 10 is a detailed side elevational view of the alternative embodiment of the coin lock box.

### DESCRIPTION OF THE PREFERRED EMBODIMENT

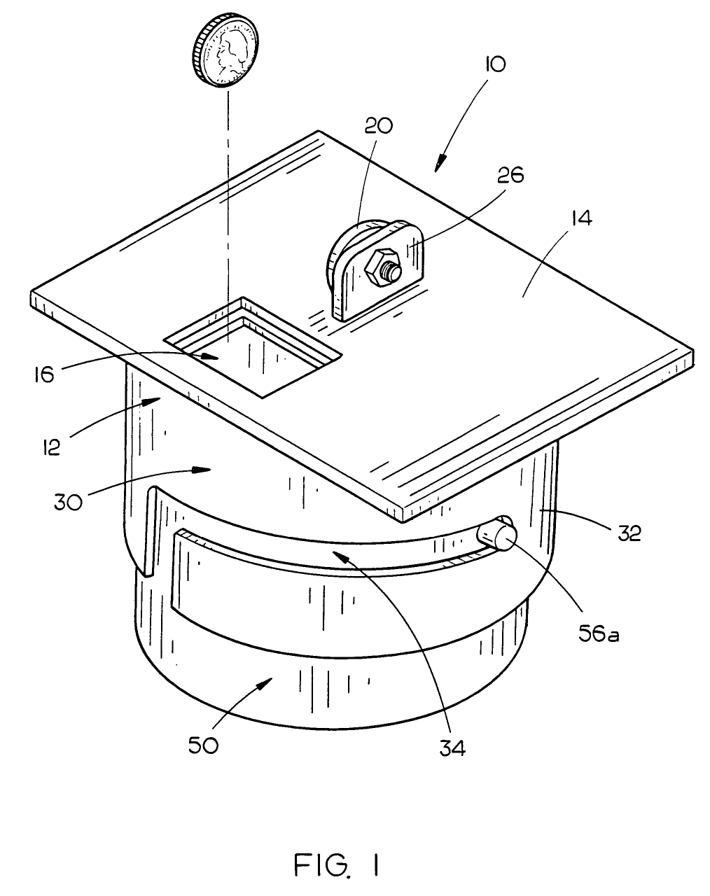

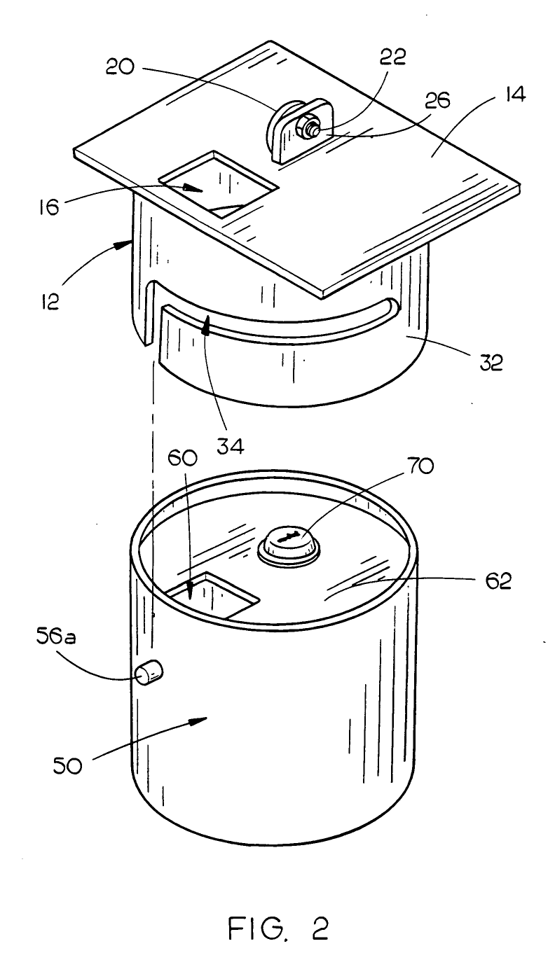

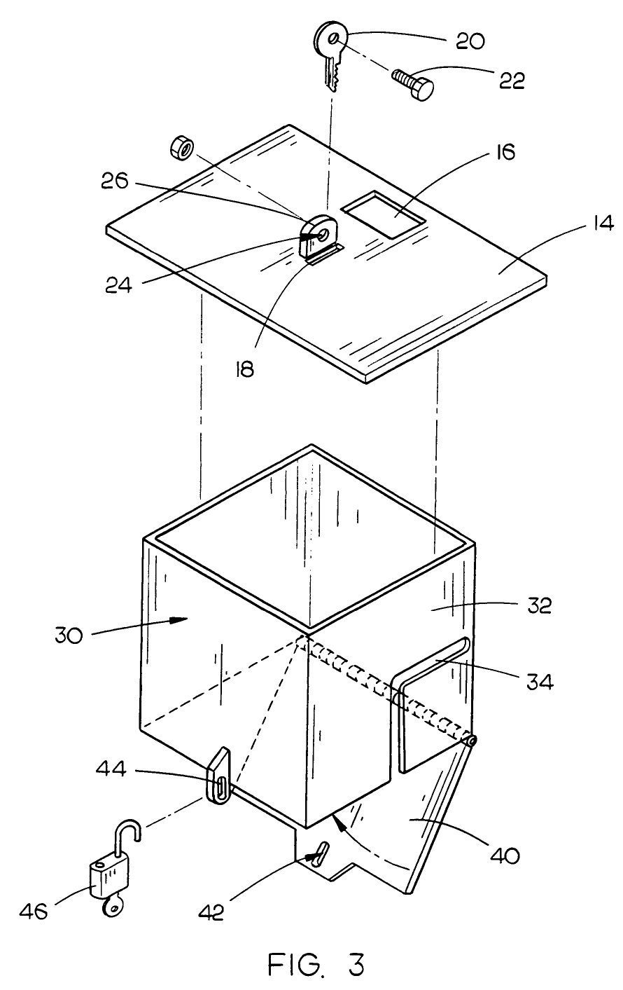

The coin lock box mechanism 10 of the present invention is best shown in FIGS. 1 and 2 as including two main sections, a coin lock box mounting section 12 and the coin lock box 50 itself which is removably and releasably mounted within the coin lock box mounting section 12, both of which are preferably constructed of metal such as steel or stainless steel to ensure longevity and strength. In the preferred embodiment, the coin lock box mounting section 12 would include a top plate 14 having a generally rectangular coin slot 16 formed therein, as shown best in FIGS. 2 and 3, and would further include a key slot 18 formed at approximately the midpoint of top plate 14. Although the key slot 18 may be of other shapes than generally rectangular, as shown in FIGS. 2 and 3, it is reasonably important that key slot 18 have a size and shape approximately equal or slightly larger than the dimensions of the key 20 which will extend into and downwards through key slot 18 to ensure that unauthorized access to the key is generally prevented. In the preferred embodiment, the key 20 would be of a standard key size and shape and would extend downwards through key slot 18, as shown best in FIGS. 1, 2, 3, and 5. The key 20 would then be secured within key slot 18 by a bolt and nut combination 22 with the bolt passing through the center hole of key 20 and into and through hole 24 formed in key mount plate 26 which is mounted on and extends upwards from top plate 14. The exact size and shape of key mount plate 26 is not critical to the present invention so long as the key 20 is properly supported within key slot 18 with the shank of the key 20 extending downwards through the key slot 18. Once the bolt and nut combination 22 has affixed key 20 to key mount plate 26, the key 20 is securely mounted on key mount plate 26 in a stationary position and cannot be removed without removing bolt and nut combination 22, which is inaccessible to unauthorized persons when mounted within the newspaper vending machine. It is an important element of the present invention that the key 20 be stationary and extend downwards through top plate 14 to engage the coin lock box 50 as will be related later in this disclosure.

Extending downwards from and mounted to the underside of top plate 14 is a coin lock box mounting structure 30 which, in the preferred embodiment, would include outer walls 32 having at least two mounting pin-receiving slots 34 formed therein. It should be further noted that although the outer walls 32 are shown as generally cylindrical in shape in FIGS. 1 and 2 and as generally rectangular in FIG. 3, the exact size and shape of the outer walls 32 is not critical to the present invention so long as they perform the function of retaining the coin lock box 50 within the outer walls 32 through the mounting pin-receiving slots 34 or another such mounting system. Therefore, as shown in FIG. 3, the outer walls 32 may be generally rectangular in shape or assume any other appropriate shape as is necessary to fit within the confines of the newspaper vending machine in which the coin lock box mechanism 10 of the present invention is to be mounted. It should also be noted that the mounting pin-receiving slots 34 guide the coin lock box 50 into the coin lock box mounting section 12, thus facilitating removal and replacement of the coin lock box 50 even in situations where visual confirmation of the positioning of the coin lock box 50 relative to the coin lock box mounting section 12 is not available.

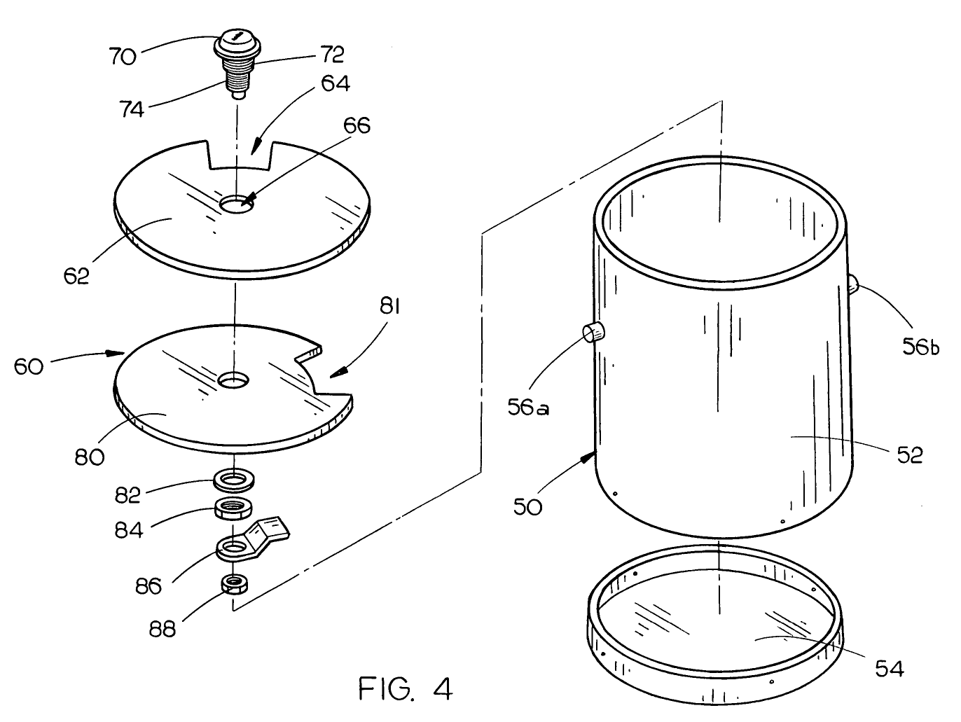

The coin lock box 50 is best shown in FIGS. 2 and 4-6 as including generally cylindrical outer wall 52, a base wall 54 mounted on the underside of outer wall 52, and a coin lock box access mechanism 60 which would preferably include the following elements. Stationary top disk 62 would be mounted on the top of outer wall 52 and would completely cover and enclose the outer wall 52, except for coin opening 64 and center lock support hole 66, as shown best in FIG. 4. Mounted on and extending through the center lock support hole 66 of stationary top plate 62 is lock mechanism 70 which, in the preferred embodiment, would be a standard key-operated locking mechanism which includes an outer stationary sleeve 72 and an inner rotating element 74 operatively connected to the lock mechanism such that when the key 20 is placed within the lock mechanism 70, the inner rotating element 74 is rotatable relative to outer sleeve 72. Mounted on inner rotating element 74 of lock mechanism 70 is lock box access plate 80 which is secured to inner rotating element 74 of lock mechanism 70 by a washer 82, inner locking nut 84, a plate support arm 86 which helps to securely mount lock box access plate 80 on inner rotating element 74 of lock mechanism 70 and prevent deformation of the lock box access plate 80 to access the interior of the coin lock box 50, and an outer locking nut 88, as shown best in FIG. 4. Lock box access plate 80 would also include a coin opening 81 formed adjacent the outer edge of lock box access plate 80 which would be of generally the same shape and size as coin opening 64 in stationary top plate 62.

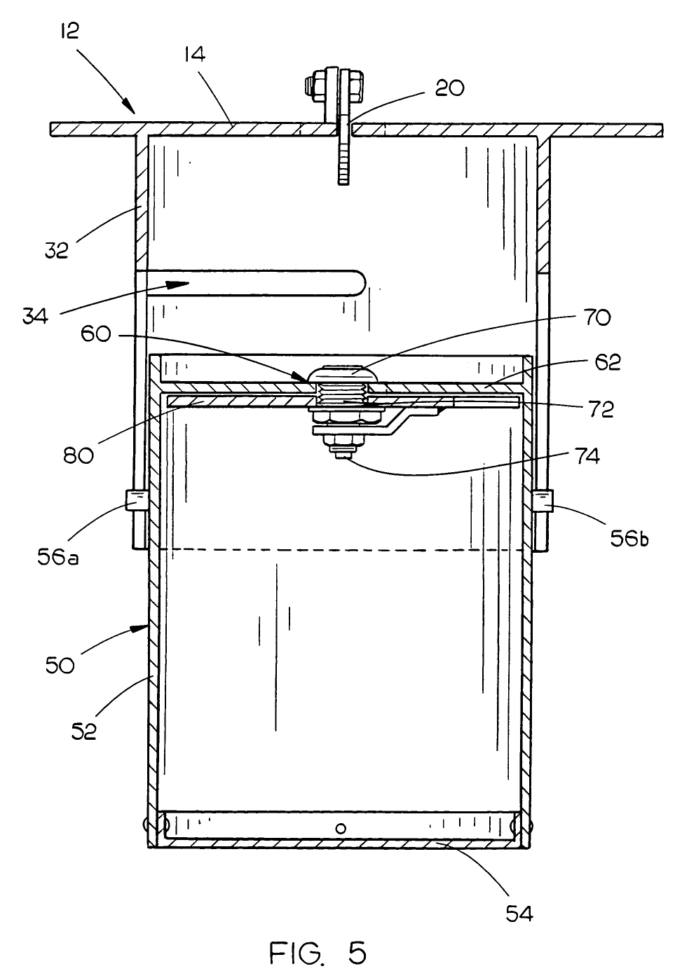

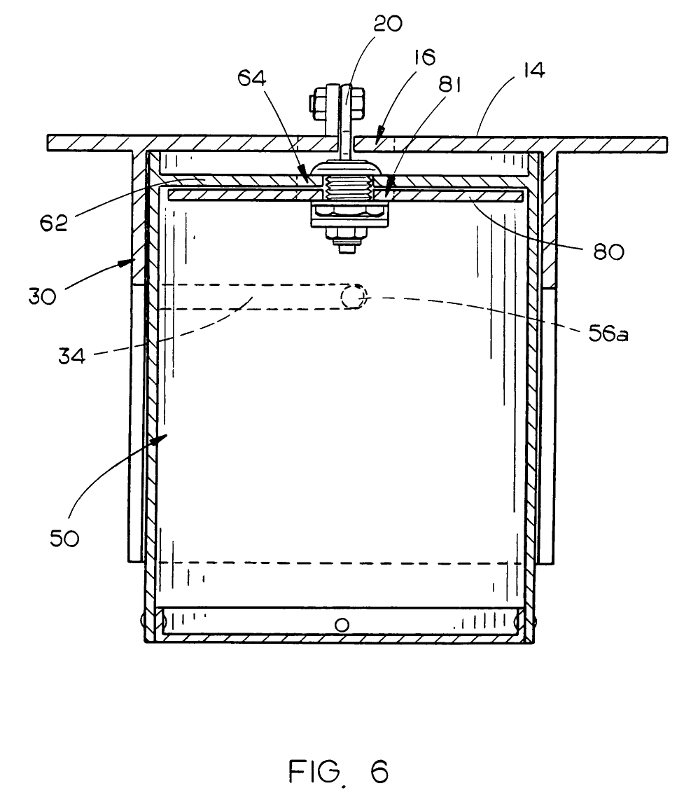

The operation of coin lock box access mechanism 60 is shown best in FIGS. 5 and 6 as the coin lock box 50 is moved upwards within coin lock box mounting section 12 with the mounting pins 56a and 56b on outer wall 52 fitting within the mounting pin-receiving slots 34 of coin lock box mounting structure 30. As the coin lock box 50 is moved upwards, the key 20 is inserted into lock mechanism 70, thus engaging the lock mechanism 70 and permitting rotation of coin lock box 50 relative to coin lock box mounting structure 30 as the mounting pins 56a and 56b slide within mounting pin-receiving slots 34. As the coin lock box 50 is rotated relative to the coin lock box mounting structure 30, the lock box access plate 80 is rotated along with inner rotating element 74 of lock mechanism 70 while the stationary top plate 62 remains stationary relative to the coin lock box 50. In fact, if the mechanism were viewed from above, the coin opening 81 of lock box access plate 80 is initially aligned with the coin slot 16 of top plate 14 and, as the coin lock box 50 is rotated relative to top plate 14 and coin lock box mounting structure 30, the coin opening 64 in stationary top plate 62 of coin lock box access mechanism 60 is rotated into alignment with the coin slot 16 of top plate 14 and coin opening 81 of lock box access plate 80. Money then dropped into the coin slot 16 of top plate 14 passes completely through the top plate 14, stationary top plate 62, and lock box access plate 80 and into the coin lock box 50.

When the coin lock box 50 is to be removed from the coin lock box mounting section 12, the coin lock box 50 is rotated in the opposite direction from what was described during installation. The coin opening 81 of lock box access plate 80 and coin opening 64 of stationary top plate 62 thus become offset and not aligned and this prevents access to the interior of coin lock box 50 and therefore access to monies deposited within the coin lock box 50. The coin lock box 50 could then be returned to the newspaper company where a supervisor would open the coin lock box and remove the coins within the coin lock box 50, thus rendering it ready for use when replaced within the coin lock box mounting section 12.

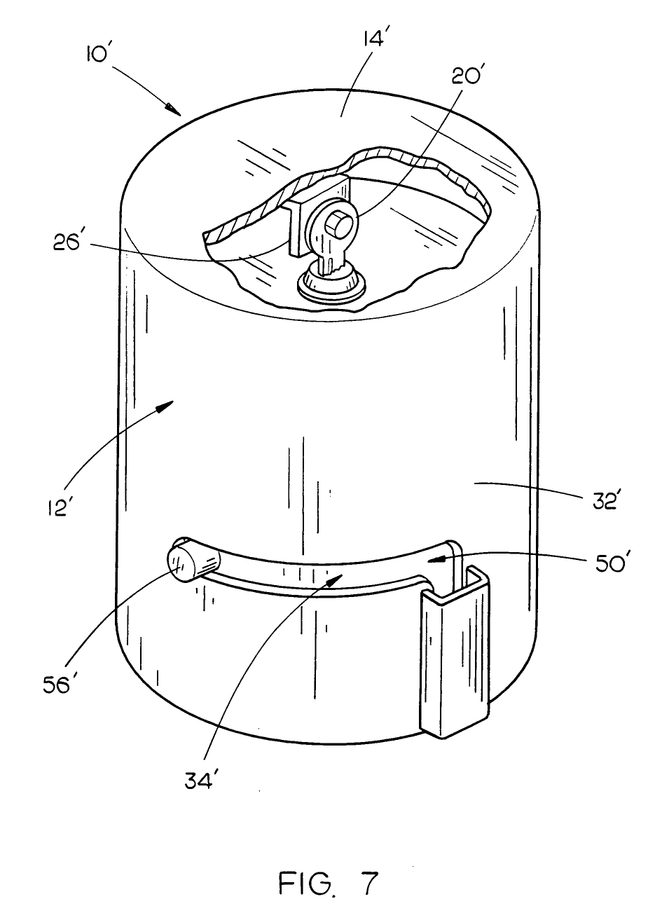

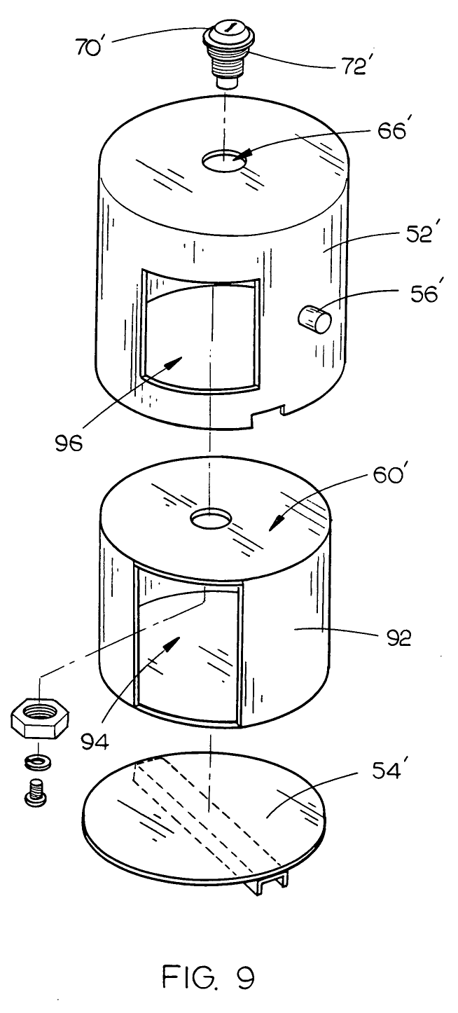

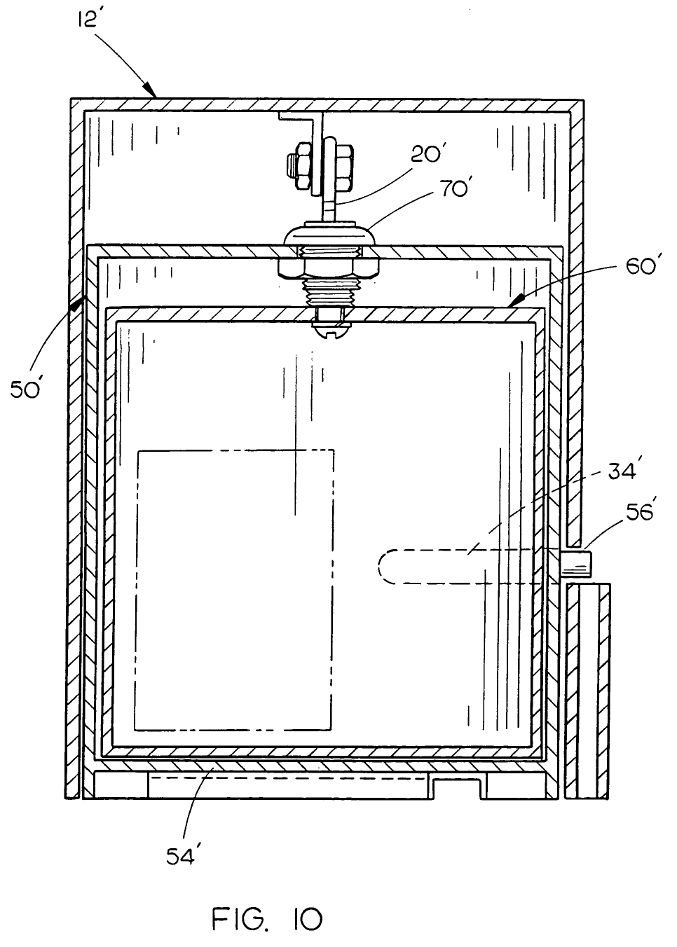

An alternative embodiment of the coin lock box mechanism 10′ of the present invention is shown best in FIGS. 7-10 as including virtually all of the same features as the coin lock box mechanism 10 described in connection with FIGS. 1-6, including the coin lock box mounting section 12′, top plate 14′, coin opening 16′ formed on the side of the coin lock box mounting section 12′ instead of the top plate 14′ thereof, key 20′, key mount plate 26′, the coin lock box mounting structure 30′ including the outer walls 32′ and the mounting pin-receiving slots 34′. The alternative embodiment also includes each of the elements of the coin lock box 50′ including generally cylindrical outer wall 52′, base wall 54′, coin lock box access mechanism 60′ having stationary top disk 62′, center lock support hole 66′, lock mechanism 70 having outer stationary sleeve 72′ and inner rotating element 74′ and lock box access plate 80′ which is secured to inner rotating element 74′ of lock mechanism 70′.

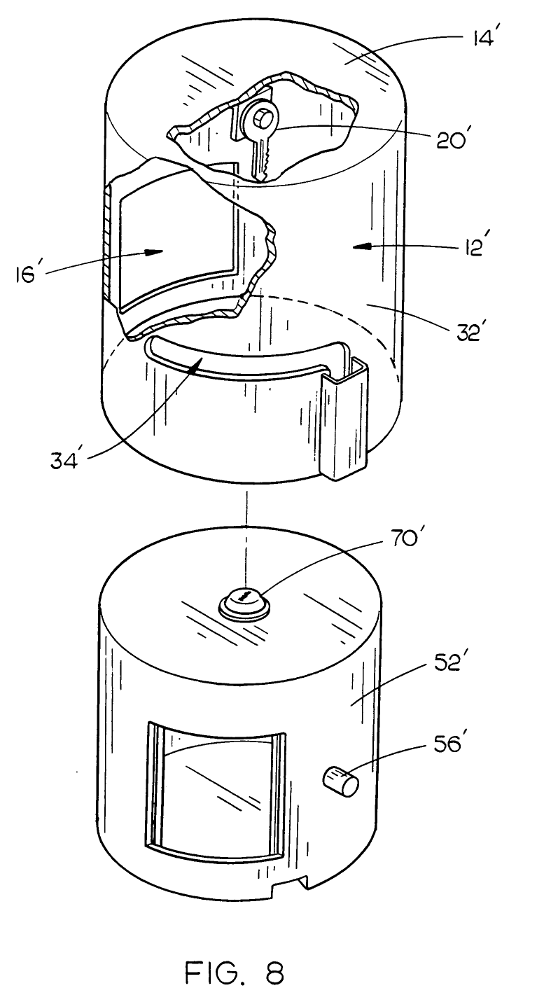

The alternative embodiment of the coin lock box mechanism 10′ as thus described is very similar in function to the embodiment described in connection with FIGS. 1-6 but includes one significant modification to permit the coin lock box mechanism 10′ to be used with a different type of vending device. Specifically, the coin lock box access mechanism 60′ would further include a lock box access cylinder 92 which is mounted on and extended downwards from the lock box access plate 80′, as shown best in FIGS. 8-10. The lock box access plate 80′ would not include a coin opening 81, as shown in FIG. 4, as the lock box access cylinder 92 would include the coin opening 94 which is formed on the side of the lock box access cylinder 92 to permit coins to pass through the lock box access cylinder 92 into the interior of the coin lock box 50′. Likewise, the coin opening 64 in stationary top plate 62 described previously in connection with the embodiments of FIGS. 1-6 would be moved to the outer wall 52′ of the coin lock box 50′ where coins may enter into the coin lock box 50′ through outer wall 52′ through the coin opening 96 in the outer wall 52′. In operation, the coin lock box 50′ would function virtually identically to the coin lock box 50 described in connection with FIGS. 1-6, with the only significant difference being that the rotation of the lock box access plate 80′ results in rotation of lock box access cylinder 92 which would bring the coin opening 94 into alignment with coin opening 96 in outer wall 52′ of coin lock box 50′, thus allowing coins to enter into the coin lock box 50′ through the aligned coin openings 94 and 96, as shown best in FIGS. 7-10.

It should be noted that by applying similar modifications to the structural elements of the coin lock box mechanism 10 and coin lock box mechanism 10′ of the present invention, virtually any type of vending machine may be retrofitted to accommodate the coin lock box mechanism 10 and 10′ of the present invention, merely by aligning the coin openings in the appropriate location as determined by the specific vending machine to which the coin lock box mechanism 10 and 10′ is being added. Finally, it should be noted that the modifications disclosed in FIGS. 7-10 would eliminate the need for the coin slot 16 found in top plate 14, and such modifications would be understood by one skilled in the art of modifying such devices.

As thus described, the coin lock box mechanism 10 of the present invention will generally prevent unauthorized access to the monies received for newspapers and thus prevent theft of the received monies. However, to generally eliminate the opportunity for theft from the coin lock box mechanism 10, it is contemplated to alternatively include a coin lock box locking plate 40 hingedly mounted on the underside of the coin lock box mounting section 12 as shown best in FIG. 3. The hinged coin lock box locking plate 40 would preferably include a slot 42 into which fits a depending lock plate 44 through which a padlock 46 or the like may be removably inserted. The coin lock box locking plate 40 thus is used to prevent unauthorized removal of the coin lock box 50 from the coin lock box mounting section 12, thus preventing theft of the coin lock box 50. Of course, other theft prevention devices may be used with the present invention, but it has been found that the coin lock box locking plate 40 as thus described performs the theft prevention function desired very well.

An additional beneficial feature of the present invention is the fact that the key remains within the coin lock box mounting section 12 at all times which ensures that the key cannot be lost or taken for duplication by the driver or any other person having access to the newspaper vending machine and this in turn ensures that monies will not be stolen from the coin lock box mechanism 10 of the present invention. Finally, because insertion and removal of the coin lock box 50 from coin lock box mounting section 12 may be quickly and easily performed, the route driver will not be inconvenienced by use of the present invention.

It is to be understood that numerous additions, modifications, and substitutions may be made to the coin lock box mechanism 10 of the present invention which fall within the intended broad scope of the appended claims. For example, although the present invention has been described for use with newspaper vending machines, it may be used with virtually any type of vending machine into which money is deposited, and such minor modifications would be understood by those skilled in the art of vending machines. Also, the precise sizes, shapes, and construction materials used in connection with the coin lock box mechanism 10 of the present invention are not critical and may be modified or changed so long as the intended functionality of the coin lock box mechanism 10 is neither degraded nor destroyed. Finally, the precise and specific mounting pin and mounting pin-receiving slot arrangement may be modified or changed depending on the size and shape of the coin lock box and coin lock box mounting structure, and in fact may be replaced entirely with a different system for securely and releasably mounting the coin lock box 50 within the coin lock box mounting section 12.

There has therefore been shown and described a coin lock box mechanism 10 which accomplishes at least all of its intended objectives.

1. A coin lock box comprising:
a coin lock box mounting section including coin lock box retention means, a coin slot formed in said coin lock box mounting section operative to permit objects to objects to enter and exit said coin lock box mounting section and a key means mounted thereon;
a coin lock box including an outer circumferential wall structure, a top wall mounted on said outer circumferential wall structure, a base wall mounted on said outer circumferential wall structure, a coin slot formed in one of said top wall and said outer circumferential wall structure and a coin lock box access mechanism operative to alternatively permit and restrict access to the interior of said coin lock box;
said coin lock box access mechanism including a lock box access plate movably mounted within said coin lock box, an access plate coin slot formed in and extending through said lock box access plate, said lock box access plate movable between an aligned position where said access plate coin slot is generally aligned with said coin slot of said coin lock box thereby allowing objects to enter and exit said coin lock box and an offset position where said access plate coin slot is generally offset from said coin slot of said coin lock box thereby restricting objects from entering and exiting said coin lock box;
lock means mounted on said coin lock box, said lock means operatively connected to said lock box access plate of said coin lock box access mechanism such that operation of said lock means moves said lock box access plate between said aligned position and said offset position; and
said key means engaging and operating said lock means upon said coin lock box being inserted and secured within said coin lock box mounting section to move said lock box access plate from said offset position to said aligned position.

2. The coin lock box of claim 1 wherein said coin lock box mounting section comprises a top wall and an outer circumferential support wall mounted on and extending downwards from said top wall.

3. The coin lock box of claim 2 wherein said coin lock box retention means comprises at least two mounting pin-receiving slots formed in said outer circumferential support wall of said coin lock box mounting section, each of said at least two mounting pin-receiving slots extending upwards and sideways from the base of said outer circumferential support wall in a general L-shape.

4. The coin lock box of claim 1 further comprising a key support structure mounted on said top wall and a key slot formed in said top wall generally adjacent said key support structure, said key means retained on said key support structure with said key means at least partially extending through said key slot downwards below said top wall for engagement with said lock means of said coin lock box when said coin lock box is inserted into said coin lock box mounting section.

5. The coin lock box of claim 3 further comprising at least two mounting pins mounted on and extending outwards from said outer circumferential wall structure of said coin lock box, said at least two mounting pins sliding within and engaging said at least two mounting pin-receiving slots in said outer circumferential support wall upon said coin lock box being inserted into said coin lock box mounting section to releasably retain said coin lock box within said coin lock box mounting section.

6. The coin lock box of claim 5 wherein said coin slot in said coin lock box mounting section is generally aligned with said coin slot in said coin lock box upon said coin lock box being inserted into said coin lock box mounting section.

7. The coin lock box of claim 1 wherein said coin lock box access mechanism further includes a stationary top disk mounted on top of said outer circumferential wall structure to completely cover and enclose said outer circumferential wall structure, said stationary top disk including a coin opening and a center lock support hole, said lock means mounted on and extending through said center lock support hole of said stationary top plate, said access plate coin slot of said lock box access plate aligning with said coin opening of said stationary top disk upon said lock box access plate being moved into said alignment position and said access plate coin slot of said lock box access plate being offset from said access plate coin slot of said lock box access plate upon said lock box access plate being moved into said offset position.

8. The coin lock box of claim 1 wherein said lock means comprises a lock mechanism including an outer stationary sleeve and an inner rotating element operatively connected to said lock mechanism such that upon said key means engaging said lock mechanism, said inner rotating element is rotatable relative to said outer stationary sleeve.

9. The coin lock box of claim 8 wherein said lock box access plate is mounted on said inner rotating element of said lock mechanism such that rotation of said inner rotating element of said lock mechanism rotates said lock box access plate between said alignment position and said offset position thereby alternatively permitting and restricting access to the interior of said coin lock box.

10. The coin lock box of claim 1 wherein said lock box access plate further comprises a lock box access cylinder mounted on and extending downwards from said lock box access plate, said access plate coin slot formed in said lock box access cylinder and extending through the side of said lock box access cylinder thereby permitting objects to pass through said access plate coin slot in said lock box access cylinder into the interior of said coin lock box.

11. The coin lock box of claim 10 wherein said coin slot of said coin lock box is formed in said outer circumferential wall structure of said coin lock box thereby permitting objects to pass through said outer circumferential wall structure of said coin lock box into the interior of said coin lock box when said coin opening in said lock box access cylinder is in alignment position due to rotation of said lock box access plate.

12. A coin lock box comprising:
a coin lock box mounting section including a top wall, an outer circumferential support wall mounted on and extending downwards from said top wall, a coin slot formed in one of said top wall and said outer circumferential support wall operative to permit objects to objects to enter and exit said coin lock box mounting section and a key means mounted on said top wall and extending downwards therefrom, said key means operative to remain mounted within said coin lock box mounting section during use of said coin lock box;
a coin lock box including an outer circumferential wall structure, a top wall mounted on said outer circumferential wall structure, a base wall mounted on said outer circumferential wall structure, a coin slot formed in one of said top wall and said outer circumferential wall structure and a coin lock box access mechanism operative to alternatively permit and restrict access to the interior of said coin lock box;
said coin lock box access mechanism including a lock box access plate movably mounted within said coin lock box, said lock box access plate further including a lock box access cylinder mounted on and extending downwards from said lock box access plate, an access plate coin slot formed in said lock box access cylinder and extending through the side of said lock box access cylinder thereby permitting objects to pass through said lock box access cylinder into the interior of said coin lock box, said lock box access plate and said lock box access cylinder movable between an aligned position where said access plate coin slot is generally aligned with said coin slot of said coin lock box thereby allowing objects to enter and exit said coin lock box and an offset position where said access plate coin slot is generally offset from said coin slot of said coin lock box thereby restricting objects from entering and exiting said coin lock box;
lock means mounted on said coin lock box, said lock means operatively connected to said lock box access plate and said lock box access cylinder of said coin lock box access mechanism such that operation of said lock means alternatively moves said lock box access plate between said aligned position and said offset position; and
said key means engaging and operating said lock means upon said coin lock box being inserted and secured within said coin lock box mounting section to move said lock box access plate from said offset position to said aligned position thereby alternatively permit and restrict access to the interior of said coin lock box thus enabling objects to be put into said coin lock box and be retained therein.

13. The coin lock box of claim 12 further comprising a key support structure mounted on said top wall and a key slot formed in said top wall generally adjacent said key support structure, said key means retained on said key support structure with said key means at least partially extending through said key slot downwards below said top wall for engagement with said lock means of said coin lock box when said coin lock box is inserted into said coin lock box mounting section.

14. The coin lock box of claim 13 further comprising at least two mounting pins mounted on and extending outwards from said outer circumferential wall structure of said coin lock box, said at least two mounting pins sliding within and engaging said at least two mounting pin-receiving slots in said outer circumferential support wall upon said coin lock box being inserted into said coin lock box mounting section to releasably retain said coin lock box within said coin lock box mounting section.

15. The coin lock box of claim 14 wherein said coin slot in said coin lock box mounting section is generally aligned with said coin slot in said coin lock box upon said coin lock box being inserted into said coin lock box mounting section.

16. The coin lock box of claim 12 wherein said lock means comprises a lock mechanism including an outer stationary sleeve and an inner rotating element operatively connected to said lock mechanism such that upon said key means engaging said lock mechanism, said inner rotating element is rotatable relative to said outer stationary sleeve.

17. The coin lock box of claim 16 wherein said lock box access plate is mounted on said inner rotating element of said lock mechanism such that rotation of said inner rotating element of said lock mechanism rotates said lock box access plate between said alignment position and said offset position thereby alternatively permitting and restricting access to the interior of said coin lock box.
